(19) United States
(12) Patent Application Publication
(10) Pub. No.: US 2015/0047588 A1
(43) Pub. Date: Feb. 19, 2015

(54) Internal Combustion Engine Valve Train Adjustment Device

(71) Applicant: Daimler AG, Stuttgart (DE)

(72) Inventors: Matthias Eppinger, Neuenhagen (DE); Kai Lehmann, Ludwigsfelde (DE); Marc Maronde, Berlin (DE); Bernd Neubauer, Schwieberdingen (DE); Tilmann Roemheld, Waiblingen (DE); Thomas Stolk, Kirchheim (DE); Alexander Von Gaisberg-Helfenberg, Beilstein (DE)

(21) Appl. No.: 14/383,225

(22) PCT Filed: Jan. 29, 2013
(86) PCT No.: PCT/EP2013/000265

§ 371 Date: Sep. 5, 2014

(30) Foreign Application Priority Data
Mar. 8, 2012 (DE) 10 2012 004 420.8

(51) Int. Cl. F01L 1/344; F02B 75/20; F02B 75/22

(52) U.S. Cl. CPC F01L 1/34413; F02B 75/22; F02B 75/20
USPC 123/90.18

(57) ABSTRACT

A device for adjusting a motor vehicle valve train includes at least one camshaft with at least four cam elements arranged in an axially displaceable manner. In each case two of the cam elements that are adjacently situated are formed as a cam element group to be switched together.

The invention relates to a device for adjusting a motor vehicle valve train according to the preamble of claim 1.

A device for adjusting a motor vehicle valve train, having at least one camshaft which includes at least four cam elements arranged in an axially displaceable manner, is already known from DE 10 2005 006 489 A1.

The object of the present invention in particular is to provide a particularly advantageous variable device for adjusting a motor vehicle valve train. This object is achieved according to the invention by the features of claim 1. Further embodiments result from the sub-claims.

The invention is directed to a device for adjusting a motor vehicle valve train, having at least one camshaft which includes at least four cam elements arranged in an axially displaceable manner.

It is proposed that in each case two of the cam elements which are adjacently situated are formed as a cam element group to be switched together. The cam elements may thus be switched in a particularly advantageous manner, and in particular the device for adjusting a motor vehicle valve train may have a particularly variable design. A “camshaft” is understood in particular to mean a shaft that is provided for activating multiple valves of an internal combustion engine and for activating one valve of at least one cam track in each case. It is also conceivable for the camshaft to be designed as an intake camshaft and provided for activating intake valves, or also for the camshaft to be designed as an exhaust camshaft and provided for activating exhaust valves. A “cam element” is understood in particular to mean an element which is mounted on a camshaft in a rotationally fixed manner, and which for activating a valve is provided for directly or indirectly acting on the valve in question with at least one lift. The term “in a rotationally fixed manner” is understood in particular to mean a connection that transmits a torque and/or a rotational motion unchanged. The term “axial” is understood in particular to mean axial in relation to a main axis of rotation of the cam element. The term “axially displaceable” is understood in particular to mean that the cam element is displaceable on the camshaft, parallel to the main axis of rotation of the cam element, between at least two switching positions. In the present context, the term “adjacently situated” is understood in particular to mean that the cam elements adjoin one another in the axial direction, and in particular no element, in particular no other cam element, is located between the adjacently situated cam elements. A “cam element group” is understood in particular to mean a grouping of two cam elements which are switchable together, the two cam elements being designed as two separate, independently formed components. The cam elements of a cam element group are in particular movable relative to one another in the axial direction of the camshaft in at least one operating state. The term “to be switched together” is understood in particular to mean that the two cam elements are always switched together by means of an activation, whereby an actual axial displacement of the cam elements may take place in a staggered manner.

It is further proposed that the two cam element groups are switchable independently of one another. The cam elements may thus be switched in a particularly advantageous manner, and the device for adjusting a motor vehicle valve train may have a particularly variable design. The term “switchable independently of one another” is understood in particular to mean that a cam element group remains uninfluenced by switching of another cam element group.

It is further proposed that the device for adjusting a motor vehicle valve train has an actuator device which in each case is associated with one of the cam element groups and which couples the two particular cam elements of the cam element group to one another during a switchover operation. The two cam element groups may thus be switched independently of one another in a particularly simple manner. An “actuator device” is understood in particular to mean a device which provides a force for switching the cam elements in order to switch the cam elements from one switching position into another switching position, and for this purpose the cam elements preferably have at least one actuator. The term “couple” is understood in particular to mean that in the switchover operation, the two cam elements of a cam element group undergo a defined movement with respect to one another due to engagement of the actuator device, and/or that a switching element of the actuator device, in particular a switch pin, is guided by a gate track of one of the cam elements directly into a gate track of the other cam element.

It is further proposed that the two cam element groups are provided for activating valves of a four-cylinder in-line engine or of one line of an eight-cylinder V engine. The activation of valves of a four-cylinder in-line engine may thus take place in a particularly advantageous manner.

In addition, it is proposed that the device for adjusting a motor vehicle valve train has a third cam element group, the three cam element groups being provided for activating valves of a six-cylinder in-line engine or of one line of a twelve-cylinder V engine. The activation of valves of a six-cylinder in-line engine may thus take place in a particularly advantageous manner.

Furthermore, it is proposed that the device for adjusting a motor vehicle valve train has a control and/or regulation unit which is provided for operating, in at least one operating state, two cam elements of one of the cam element groups in a different switching position than the two cam elements of another of the cam element groups. Cylinders which are associated with the cam elements of the one cam element group may thus advantageously be operated with a different valve lift than the cylinders which are associated with the cam elements of another cam element group. A “control and/or regulation unit” is understood in particular to mean a unit having at least one control device. A “control device” is understood in particular to mean a unit having a processor unit and a memory unit, and having an operating program which is stored in the memory unit. In principle, the control and/or regulation unit may have multiple interconnected control devices which are preferably provided for communicating with one another via a bus system, in particular a CAN bus system. The term “provided” is understood in particular to mean specially programmed, designed, and/or equipped. The term “switching position of a cam element” is understood in particular to mean a defined position of the cam element which the cam element assumes after completion of a switching operation, and in which a defined cam track is engaged with the valve in question. The term “operating a different switching position” is understood in particular to mean that the cam elements of the one cam element group activate the valves associated with them with a valve lift which differs from a valve lift with which the cam elements of the other cam element group activate the valves associated with them. In this regard, the lift height and/or lift characteristic of the valve lifts may be different and/or may start in a staggered manner.

It is further proposed that in at least one operating state, the control and/or regulation unit is provided for initially switching the cam element group whose first cam element is the next to reach its base circle phase. Switching of the cam elements may thus take place particularly quickly. A “first cam element of a cam element group” is understood in particular to mean the cam element of the two cam elements which are combined to form a cam element group, whose associated cylinder, considered starting from a firing order of the two cylinders associated with the cam elements, has an ignition point which chronologically precedes an ignition point of the cylinder which is associated with the second cam element.

Further advantages result from the following description of the drawings. Two exemplary embodiment of the invention are illustrated in the drawings. The drawings, the description, and the claims contain numerous features in combination. Those skilled in the art will also advantageously consider the features individually and combine them into further meaningful combinations.

The figures show the following:

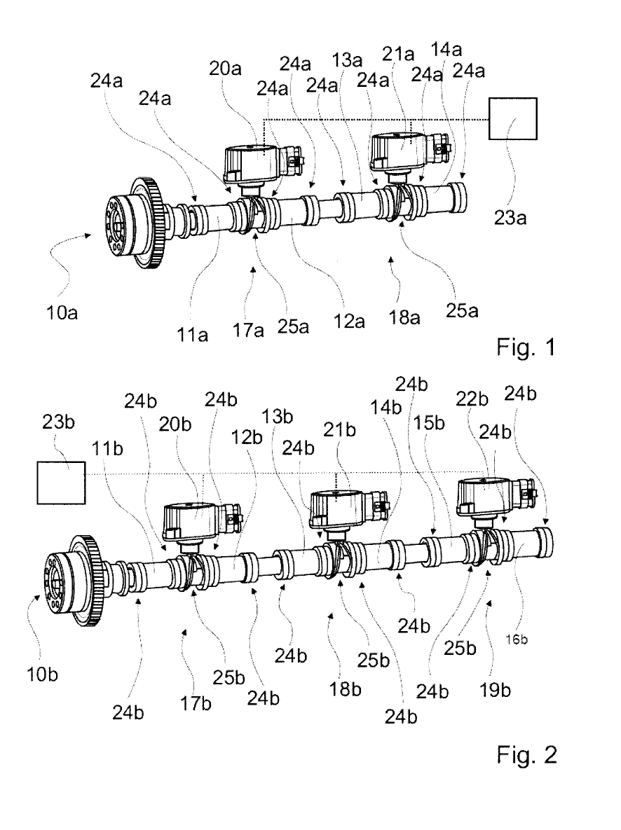

FIG. 1 a device according to the invention for adjusting a motor vehicle valve train in a first exemplary embodiment; and

FIG. 2 a device according to the invention for adjusting a motor vehicle valve train in a second exemplary embodiment.

FIG. 1 shows a device according to the invention for adjusting a motor vehicle valve train in a first exemplary embodiment. The device for adjusting a motor vehicle valve train is part of an internal combustion engine for a motor vehicle, not illustrated in greater detail. The internal combustion engine is part of a motor vehicle, not illustrated in greater detail, and has four cylinders, not illustrated in greater detail. The internal combustion engine is designed as a four-cylinder in-line engine. In principle, it is also conceivable for the internal combustion engine to have a different number of cylinders that appears meaningful to one skilled in the art. For each cylinder, the internal combustion engine has two valves, not illustrated in greater detail, which are designed as intake valves, and two valves, not illustrated in greater detail, which are designed as exhaust valves. In principle, it is also conceivable for the internal combustion engine to have only one intake valve and one exhaust valve for each cylinder, or some other number of intake and/or exhaust valves that appears meaningful to one skilled in the art. The device for adjusting a motor vehicle valve train has a camshaft 10a, designed as an intake camshaft, which is provided for activating the valves designed as intake valves, and a camshaft, not illustrated in greater detail, which is designed as an exhaust camshaft and which is provided for activating the valves designed as exhaust valves. For reasons of clarity, only the camshaft 10a which is designed as an intake camshaft is described below. In principle, the camshaft which is designed as an exhaust camshaft may have essentially the same design as the camshaft 10a described below which is designed as an intake camshaft. The camshaft 10a which is designed as an intake camshaft and the camshaft which is designed as an exhaust camshaft may act with different lifts on the valves which they activate; the lifts may differ in their maximum lift as well as in a lift characteristic. The camshaft 10a is rotatably supported in a cylinder head of the internal combustion engine.

The camshaft 10a includes four cam elements 11a, 12a, 13a, 14a arranged in an axially displaceable manner. The cam elements 11a, 12a, 13a, 14a are connected in a rotationally fixed manner to the camshaft 10a via a positive fit, not illustrated in greater detail. The cam elements 11a, 12a, 13a, 14a are displaceable between two switching positions in an axial direction which extends parallel to an axis of rotation of the camshaft 10a. In principle, it is also conceivable for the cam elements 11a, 12a, 13a, 14a to be connected to the camshaft 10a in some other way that appears meaningful to one skilled in the art. The first cam element 11a is associated with the first cylinder and the corresponding valves. The second cam element 12a is associated with the second cylinder and the corresponding valves. The third cam element 13a is associated with the third cylinder and the corresponding valves. The fourth cam element 14a is associated with the fourth cylinder and the corresponding valves.

The axially displaceable cam elements 11a, 12a, 13a, 14a are provided for activating and adjusting a valve lift in each case of two valves of a cylinder. For this purpose, the cam elements 11a, 12a, 13a, 14a each have two cam tracks 24a for one valve in each case. Each of the cam elements 11a, 12a, 13a, 14a has two first cam tracks 24a and two second cam tracks 24a. One first cam track 24a and one second cam track 24a in each case are associated with the same valve of a cylinder, and have different valve lifts and lift characteristics. The first cam tracks 24a and the second cam tracks 24a, which in each case are associated with the same valve of the particular cylinder, are adjacently situated in each case on the respective cam element 11a, 12a, 13a, 14a. The first cam tracks 24a of the cam elements 11a, 12a, 13a, 14a are provided for a small valve lift. The second cam tracks 24a of the cam elements 11a, 12a, 13a, 14a are provided for a large valve lift. In a first switching position of the cam elements 11a, 12a, 13a, 14a, the first cam tracks 24a activate the corresponding valves. In a second switching position of the cam elements 11a, 12a, 13a, 14a, the second cam tracks 24a activate the corresponding valves. For adjusting a valve lift of the valves of a cylinder, the corresponding cam element 11a, 12a, 13a, 14a is switched from one switching position into the other switching position.

In each case two of the cam elements 11a, 12a, 13a, 14a which are adjacently situated are designed as a cam element group 17a, 18a to be switched together. The first cam element 11a, which is associated with the first cylinder, and the second cam element 12a, which is associated with the second cylinder, form the cam element group 17a to be switched together. The third cam element 13a, which is associated with the third cylinder, and the fourth cam element 14a, which is associated with the fourth cylinder, form the second cam element group 18a to be switched together. The cam elements 11a, 12a, 13a, 14a of one of the cam element groups 17a, 18a are in each case designed separate from one another as independent single components. The cam elements 11a, 12a, 13a, 14a of a cam element group 17a, 18a are in each case switched together during a switchover operation. Initially, in each case the first of the two cam elements 11a, 12a, 13a, 14a of a cam element group 17a, 18a is switched.

The two cam element groups 17a, 18a are switchable independently of one another. The first cam element group 17a, which is formed by the first cam element 11a and the second cam element 12a, is switchable independently from the second cam element group 18a, which is formed by the third cam element 13a and the fourth cam element 14a. A switching position of the first cam element 11a and of the second cam element 12a, which form the first cam element group 17a, may be changed regardless of whether the third cam element 13a and the fourth cam element 14a, which form the second cam element group 18a, are switched. The converse also applies. A switching position of the third cam element 13a and of the fourth cam element 14a, which form the second cam element group 18a, may be changed regardless of whether the first cam element 11a and the second cam element 12a, which form the first cam element group 17a, are switched. After a switchover operation, the cam elements 11a, 12a, 13a, 14a of a cam element group 17a, 18a, i.e., the first cam element 11a and the second cam element 12a, as well as the third cam element 13a and the fourth cam element 14a, in each case always have the same switching position.

The device for adjusting a motor vehicle valve train has two actuator devices 20a, 21a. One actuator device 20a, 21a is associated with one of the cam element groups 17a, 18a, respectively. The actuator devices 20a, 21a couple together the cam elements 11a, 12a, 13a, 14a of the cam element group 17a, 18a associated with them during a switchover operation. The first actuator device 20a is associated with the first cam element group 17a, and is provided for switching the first cam element 11a and the second cam element 12a. The second actuator device 21a is associated with the second cam element group 18a, and for this purpose is provided for switching the third cam element 13a and the fourth cam element 14a.

The first actuator device 20a and the second actuator device 21a have the same design. The first actuator device 20a has a schematically illustrated gate track 25a. A first portion of the gate track 25a is formed in one piece with the first cam element 11a, which is associated with the first cylinder. A second portion of the gate track 25a is formed in one piece with the second cam element 12a, which is associated with the second cylinder. The first and the second portions of the gate track 25a are circumferentially introduced into the first cam element 11a and the second cam element 12a, respectively. The first portion of the gate track 25a merges into the second portion of the gate track 25a. The second portion of the gate track 2a [sic; 25a] merges into the first portion of the gate track 25a. The actuator device 20a includes an actuator. The actuator includes a switching element which is designed as a switch pin. During a switchover operation, the switching element engages with the gate track 25a of the actuator device 20a. When the switchover operation starts, the switching element always initially engages with the first portion of the gate track 25a. As a result, the actuator device 20a initially switches the first cam element 11a from one switching position into the other switching position. If the switching element has come to the end of the first portion of the gate track 25a, the first cam element 11a is switched into the switching position to be switched, and the switching element enters the second portion of the gate track 25a and now switches the second cam element 12a into the switching position to be switched.

The second actuator device 21a likewise has a schematically illustrated gate track 25a. A first portion of the gate track 25a is formed in one piece with the third cam element 13a, which is associated with the third cylinder. A second portion of the gate track 25a is formed in one piece with the fourth cam element 14a, which is associated with the fourth cylinder. The first and the second portions of the gate track 25a are circumferentially introduced into the third cam element 13a and the fourth cam element 14a, respectively. The first portion of the gate track 25a merges into the second portion of the gate track 25a. The second portion of the gate track 25a merges into the first portion of the gate track 25a. The actuator device 21a includes an actuator. The actuator includes a switching element which is designed as a switch pin. During a switchover operation, the switching element engages with the gate track 25a of the actuator device 21a. When the switchover operation starts, the switching element always initially engages with the first portion of the gate track 25a. As a result, the actuator device 21a initially switches the third cam element 13a from one switching position into the other switching position. If the switching element has come to the end of the first portion of the gate track 25a, the third cam element 13a is switched into the switching position to be switched, and the switching element enters the second portion of the gate track 25a and now switches the fourth cam element 14a into the switching position to be switched.

The device for adjusting a motor vehicle valve train has a control and regulation unit 23a. The control and regulation unit 23a is provided for switching the first actuator device 20a and the second actuator device 21a. The cam elements 11a, 12a of the first cam element group 17a and the cam elements 13a, 14a of the second cam element group 18a may be switched via control by the control and regulation unit 23a. The control and regulation unit 23a is provided for operating, in at least one operating state, two cam elements 11a, 12a, 13a, 14a of one of the cam element groups 17a, 18a in a different switching position than two cam elements 11a, 12a, 13a, 14a of another of the cam element groups 17a, 18a. For this purpose, the control and regulation unit 23a, starting from an operating state in which all cam elements 11a, 12a, 13a, 14a are in the same switching position, switches by means of the appropriate actuator device 20a, 21a only the cam elements 11a, 12a of the first cam element group 17a, or only the cam elements 13a, 14a of the second cam element group 18a. The various cylinders of the internal combustion engine may thus be operated with different valve lifts, as the result of which different power levels may be generated. Thus, for example, it is conceivable for an internal combustion engine power of 100 kW to be composed of two different packets, for example a first packet of 70 kW from the first cylinder and the second cylinder, whose associated cam elements 11a, 12a are operated in a first switching position, and a second packet of 30 kW from the third cylinder and the fourth cylinder, whose associated cam elements 13a, 14a are operated in a second switching position. The 100 kW may thus be generated at a higher efficiency than when all cylinders are operated under the same load, i.e., when all cam elements 11a, 12a, 13a, 14a are operated in the same switching position.

The control and regulation unit 23a is provided for initially switching the cam element group 17a, 18a whose first cam element 11a, 13a, respectively, is the next to reach its base circle phase. A cam element 11a, 12a, 13a, 14a is in the base circle phase when the corresponding cam element 11a, 12a, 13a, 14a does not activate the valve associated with it. As a function of a point in time when a switchover operation of the cam elements is requested, the second cam element group 18a with its two cam elements 13a, 14a may initially be switched when, at the time of the request for the switchover operation, the third cam element 13a is the next to reach its base circle phase. When the first cam element 11a is the next to reach its base circle phase at the time of the request for the switchover operation, initially the cam elements 11a, 12a of the first cam element group 17a are switched.

The two cam element groups 17a, 18a are provided for activating the valves of the internal combustion engine, which is designed as a four-cylinder in-line engine. In principle, it is also conceivable for the two cam element groups 17a, 18a to be provided for activating valves of one line of an eight-cylinder V engine. One embodiment of the cam element groups 17a, 18a and of the actuator devices 20a, 21a for the line of an eight-cylinder V engine corresponds to the embodiment described here. For providing the device for adjusting a motor vehicle valve train for the entire eight-cylinder V engine, a further camshaft 10a having two additional cam element groups 17a, 18a and the corresponding actuator devices 20a, 21a is necessary.

FIG. 2 shows another exemplary embodiment of the invention. The following descriptions are limited essentially to the differences between the exemplary embodiments, wherein reference may be made to the description of the exemplary embodiment in FIG. 1 with regard to components, features, and functions which remain the same. For distinguishing the exemplary embodiments, the letter “a” in the reference numerals for the exemplary embodiment in FIG. 1 is replaced by the letter “b” in the reference numerals for the exemplary embodiment in FIG. 2. With regard to components denoted in the same way, in particular components having the same reference numerals, reference may basically also be made to the drawings and/or the description of the exemplary embodiment in FIG. 1.

FIG. 2 shows a device according to the invention for adjusting a motor vehicle valve train in a second exemplary embodiment. The device for adjusting a motor vehicle valve train is part of an internal combustion engine for a motor vehicle, not illustrated in greater detail. The internal combustion engine is part of a motor vehicle (not illustrated in greater detail) and, in contrast the first exemplary embodiment, has six cylinders (not illustrated in greater detail). The internal combustion engine is designed as a six-cylinder in-line engine.

The device for adjusting a motor vehicle valve train includes a camshaft 10b, which in contrast to the first exemplary embodiment includes six cam elements 11b, 12b, 13b, 14b, 15b, 16b arranged in an axially displaceable manner. The axially displaceable cam elements 11b, 12b, 13b, 14b, 15b, 16b are provided for activating and adjusting a valve lift in each case of two valves of a cylinder. In each case two of the cam elements 11b, 12b, 13b, 14b, 15b, 16b which are adjacently situated are designed as a cam element group 17b, 18b, 19b to be switched together. The first cam element 11b, which is associated with the first cylinder, and the second cam element 12b, which is associated with the second cylinder, form the cam element group 17b to be switched together. The third cam element 13b, which is associated with the third cylinder, and the fourth cam element 14b, which is associated with the fourth cylinder, form the second cam element group 18b to be switched together. The fifth cam element 15b, which is associated with the fifth cylinder, and the sixth cam element 16b, which is associated with the sixth cylinder, form the third cam element group 19b to be switched together. The three cam element groups 17b, 18b, 19b are switchable independently of one another. The device for adjusting a motor vehicle valve train has three actuator devices 20b, 21b, 22b. One actuator device 20b, 21b, 22b is associated with each of the cam element groups. All three actuator devices 20b, 21b, 22b have the same design, and correspond to the description for FIG. 1.

The three cam element groups 20b, 21b, 22b are provided for activating valves of the internal combustion engine designed as a six-cylinder in-line engine. In principle, it is also conceivable for the three cam element groups 20b, 21b, 22b to be provided for activating valves of one line of a twelve-cylinder V engine. One embodiment of the cam element groups 20b, 21b, 22b and of the actuator devices 20b, 21b, 22b for the line of a twelve-cylinder V engine corresponds to the embodiment described here. For providing the device for adjusting a motor vehicle valve train for the entire twelve-cylinder V engine, a further camshaft 10b having three additional cam element groups 20b, 21b, 22b and the corresponding actuator devices 20b, 21b, 22b is necessary.

### LIST OF REFERENCE NUMERALS

10 Camshaft
11 Cam element
12 Cam element
13 Cam element
14 Cam element
15 Cam element
16 Cam element
17 Cam element group
18 Cam element group
19 Cam element group
20 Actuator device
21 Actuator device
22 Actuator device
23 Control and/or regulation unit
24 Cam tracks
25 Gate track

1-10. (canceled)

11. A device for adjusting a motor vehicle valve train having at least one camshaft with at least four cam elements arranged in an axially displaceable manner, wherein a first two adjacently arranged cam elements of the at least four cam elements are formed as a first cam element group and a second two adjacently arranged cam elements of the at least four cam elements are formed as a second cam element group, wherein the device is configured to switch the first two adjacently arranged cam elements together and to switch the second two adjacently arranged cam elements together, and wherein the at least four cam elements are separate, independently formed components.

12. The device of claim 11, wherein device is configured to switch the first and second cam elements groups independently of one another.

13. The device of claim 11, further comprising:
a first actuator associated with the first cam element group and which couples the first two adjacently arranged cam elements to one another during a switchover operation; and
a second actuator associated with the second cam element group and which couples the second two adjacently arranged cam elements to one another during a switchover operation.

14. The device of claim 11, wherein the first and second cam element groups are configured to activate valves of a four-cylinder in-line engine or of one line of an eight-cylinder V engine.

15. The device of claim 11, further comprising:
a third cam element group, wherein the first, second, and third cam element groups are configured to activate valves of a six-cylinder in-line engine or of one line of a twelve-cylinder V engine.

16. The device of claim 11, further comprising:
a control or regulation unit configured to operate, in at least one operating state, two cam elements of one of the first and second cam element groups in a different switching position than the two cam elements of another of the first and second cam element groups.

17. The device of claim 16, wherein in at least one operating state, the control or regulation unit is configured to initially switch a cam element group of the first and second cam element groups whose first cam element is a next one to reach its base circle phase.

18. An internal combustion engine, comprising:
a motor vehicle valve train having at least one camshaft with at least four cam elements arranged in an axially displaceable manner, wherein a first two adjacently arranged cam elements of the at least four cam elements are formed as a first cam element group and a second two adjacently arranged cam elements of the at least four cam elements are formed as a second cam element group, and wherein the at least four cam elements are separate, independently formed components; and
a device configured to switch the first two adjacently arranged cam elements together and to switch the second two adjacently arranged cam elements together.

19. The engine of claim 18, wherein device is configured to switch the first and second cam elements groups independently of one another.

20. The engine of claim 18, further comprising:
a first actuator associated with the first cam element group and which couples the first two adjacently arranged cam elements to one another during a switchover operation; and
a second actuator associated with the second cam element group and which couples the second two adjacently arranged cam elements to one another during a switchover operation.

21. The engine of claim 18, wherein the first and second cam element groups are configured to activate valves of a four-cylinder in-line engine or of one line of an eight-cylinder V engine.

22. The engine of claim 18, further comprising:
a third cam element group, wherein the first, second, and third cam element groups are configured to activate valves of a six-cylinder in-line engine or of one line of a twelve-cylinder V engine.

23. The engine of claim 18, further comprising:
a control or regulation unit configured to operate, in at least one operating state, two cam elements of one of the first and second cam element groups in a different switching position than the two cam elements of another of the first and second cam element groups.

24. The engine of claim 23, wherein in at least one operating state, the control or regulation unit is configured to initially switch a cam element group of the first and second cam element groups whose first cam element is a next one to reach its base circle phase.

25. A method, comprising:
forming a first cam element group of a first two adjacently arranged cam elements of at least four cam elements arranged in an axially displaceable manner;
forming a second cam element group of a second two adjacently arranged cam elements of the at least four cam elements;
switching the first two adjacently arranged cam elements together; and
switching the second two adjacently arranged cam elements together,
wherein the at least four cam elements are separate, independently formed components.

26. The method of claim 25, wherein in at least one operating state, two cam elements of one of the first and second cam element groups are operated in a different switching position than two cam elements of another of the first and second cam element groups.

27. The method of claim 25, wherein the first and second cam elements groups are switched independently of one another.
